(19) United States
(12) Patent Application Publication
(10) Pub. No.: US 2026/0307558 A1
(43) Pub. Date: Oct. 8, 2026

(54) WALK-THROUGH POP-UP SEAT MOUNTING STRUCTURE OF VEHICLE

(71) Applicants: Kia Corporation, Seoul (KR); Hyundai Motor Company, Seoul (KR)

(72) Inventors: Jiae Yong, Hwaseong-si (KR); Dong Wook Kim, Hwaseong-si (KR); Sung Woong Ha, Hwaseong-si (KR)

(21) Appl. No.: 19/566,458

(22) Filed: Mar. 13, 2026

(30) Foreign Application Priority Data
Apr. 2, 2025 (KR) 10-2025-0042542
Dec. 3, 2025 (KR) 10-2025-0189172

(51) Int. Cl. B60N 2/30; B60N 2/015; B60N 3/06; B60R 21/02

(52) U.S. Cl. CPC B60N 2/3075; B60N 2/015; B60N 3/06; B60R 21/026

(57) ABSTRACT

A walk-through pop-up seat mounting structure of a vehicle may include a walk-through partition wall disposed on a front floor providing a front bottom surface of a vehicle body, wherein the walk-through partition wall divides a passenger compartment and a cargo room of the vehicle, a pop-up seat mounted in front of the walk-through partition wall on the front floor, wherein the pop-up seat is configured to be folded or unfolded, and a walk-through partition wall mounting part mounted between the walk-through partition wall and the pop-up seat on the front floor, wherein the pop-up seat is supported by the walk-through partition wall mounting part.

### CROSS-REFERENCE TO RELATED APPLICATIONS

This application claims priority to and the benefit of Korean Patent Application No. 10-2025-0042542 filed with the Korean Intellectual Property Office on Apr. 2, 2025, and Korean Patent Application No. 10-2025-0189172 filed with the Korean Intellectual Property Office on Dec. 3, 2025, the entire contents of which are incorporated herein by reference.

### TECHNICAL FIELD

The present disclosure relates to a walk-through pop-up seat mounting structure of a vehicle.

### BACKGROUND

In general, a passenger compartment and a cargo room of a vehicle are separated by a partition wall, and an opening is formed in the partition wall to allow movement between the passenger compartment and the cargo room through the partition wall.

A door capable of being opened and closed may be installed in the opening, and a structure in which the opening is formed is mainly applied to the side and rear of a driver’s seat.

However, in a structure with only the driver’s seat and no passenger seat, the number of passengers is limited to one, which reduces usability and marketability.

In a structure with a passenger seat installed, the opening is blocked when the passenger seat is in a standing position, reducing usability.

Therefore, in a structure with a walk-through partition wall installed, there is a need for a structure that allows the vehicle to be used with a two-passenger front-row seat under normal conditions, incorporates a pop-up seat configuration in which the front passenger seat may be folded to enable movement from the passenger compartment to the cargo room, and strongly supports the walk-through partition wall.

### SUMMARY

The present disclosure relates to a walk-through pop-up seat mounting structure of a vehicle, and relates to a walk-through pop-up seat mounting structure of a vehicle capable of moving between a passenger compartment and a cargo room of the vehicle through a walk-through partition wall.

Some embodiments of the present disclosure may solve the above-described problems, and may provide a vehicle walk-through pop-up seat mounting structure that secures convenience and rigidity by placing a foldable pop-up seat that functions as a passenger seat in the vehicle’s passenger compartment and applying a structure that strongly supports the walk-through partition wall that divides the passenger compartment and a cargo room.

A walk-through pop-up seat mounting structure of a vehicle according to an embodiment of the present disclosure may include a walk-through partition wall formed on a front floor forming the front bottom surface of a vehicle body to divide a passenger compartment and a cargo room of the vehicle, a pop-up seat provided in front of the walk-through partition wall on the front floor and to be folded or unfolded, and a walk-through partition wall mounting part provided between the walk-through partition wall and the pop-up seat on the front floor and supporting the pop-up seat.

The walk-through partition wall mounting part may include a channel partition reinforcing member supporting the walk-through partition wall and a center floor upper member supporting the rear end of the pop-up seat.

The center floor upper member may have a pop-up seat rear mounting part supporting the rear end of the pop-up seat.

On the rear end of the pop-up seat, a pop-up seat rear support may be formed to be supportively coupled to the upper surface of the pop-up seat rear mounting part.

On the side of the pop-up seat on the front floor, a flattened footrest may be further provided to have the same horizontal plane as the pop-up seat when the pop-up seat is in a folded state.

In the center floor upper member, a flattened footrest rear mounting part may be provided to support the rear end of the flattened footrest.

The flattened footrest rear mounting part may include a center support mounting bracket coupled in a protruding form to the upper surface of the center floor upper member, and a center support mounting bracket cover member covering the center support mounting bracket and having a lower portion that is coupled to the front and rear surfaces of the center floor upper member.

The pop-up seat rear mounting part may include a center floor reinforcing member coupled in a protruding form to the upper surface of the center floor upper member, and a center floor rear tunnel stay covering the center floor reinforcing member and having a lower portion that is coupled to the front and rear surfaces of the center floor upper member.

On the front floor, a pop-up seat front mounting part to which the front end of the pop-up seat may be mounted.

On both sides of the front end of the pop-up seat, a front inner mounting bracket and a front outer mounting bracket extending in the length direction of the vehicle body may be further provided.

On the front floor, a flattened footrest front mounting part that supports the front end of the flattened footrest may be provided.

At the bottom of the front floor, a battery crossmember extending in a horizontal direction of the vehicle body and a lower support structure bracket connected to the battery crossmember and extending in the length direction of the vehicle body may be provided.

A stay mounting bracket may be inserted and connected to the battery crossmember, and the stay mounting bracket may be connected to the bottom of the pop-up seat on the lower surface of the front floor.

On the side of the front end of the flattened footrest, a front center mounting bracket may be further provided to be spaced apart from the front inner mounting bracket such that the flattened footrest is disposed therebetween.

According to some embodiments of the present disclosure, a foldable or unfoldable pop-up seat that functions as a passenger seat may be disposed in the passenger compartment of a vehicle, and it may be possible to freely move between the passenger compartment and the cargo room through the walk-through partition wall without getting out of the vehicle, thereby improving space utilization and convenience of movement.

According to some embodiments of the present disclosure, by adding a reinforcing member that supports the walk-through partition wall and a rigid member that supports the pop-up seat, the supporting rigidity may be secured.

According to some embodiments of the present disclosure, by adding a flattened footrest to the side of the pop-up seat, the flattened footrest may serve as a footrest when moving to the cargo room and support the load, thereby improving the convenience of movement and securing rigidity.

According to some embodiments of the present disclosure, by sharing various design elements of current vehicle models and adding walk-through partition walls, pop-up seats, and flattened support structures, there may be a cost-saving effect through shared use of the basic vehicle.

### BRIEF DESCRIPTION OF THE DRAWINGS

FIG. 1 illustrates an unused state of a walk-through partition wall in a walk-through pop-up seat mounting structure of a vehicle according to an embodiment of the present disclosure.

FIG. 2 illustrates a state of use of a walk-through partition wall in a walk-through pop-up seat mounting structure of a vehicle according to an embodiment of the present disclosure.

FIG. 3 illustrates a walk-through pop-up seat mounting structure of a vehicle according to an embodiment of the present disclosure.

FIG. 4 illustrates a pop-up seat front mounting structure and a flattened footrest front mounting structure in a walk-through pop-up seat mounting structure of a vehicle according to an embodiment of the present disclosure.

FIG. 5 illustrates a pop-up seat rear mounting structure and a flattened footrest rear mounting structure in a walk-through pop-up seat mounting structure of a vehicle according to an embodiment of the present disclosure.

FIG. 6 illustrates a channel partition reinforcing member structure and a center floor upper member structure in a walk-through pop-up seat mounting structure of a vehicle according to an embodiment of the present disclosure.

FIG. 7 illustrates a flattened footrest and a mounting structure in a walk-through pop-up seat mounting structure of a vehicle according to an embodiment of the present disclosure.

FIG. 8 illustrates a mounting bracket structure provided on both sides of a flattened footrest in a walk-through pop-up seat mounting structure of a vehicle according to an embodiment of the present disclosure.

FIG. 9 illustrates a pop-up seat rear mounting part and a flattened footrest rear mounting part in a walk-through pop-up seat mounting structure of a vehicle according to an embodiment of the present disclosure.

FIG. 10 illustrates a structure of mounting brackets provided on both sides of a pop-up seat and a stay mounting bracket disposed therebetween in a walk-through pop-up seat mounting structure of a vehicle according to an embodiment of the present disclosure.

FIG. 11 illustrates a vehicle body connection structure of mounting brackets provided on both sides of a pop-up seat in a walk-through pop-up seat mounting structure of a vehicle according to an embodiment of the present disclosure.

FIG. 12 illustrates a pop-up seat front mounting part in a walk-through pop-up seat mounting structure of a vehicle according to an embodiment of the present disclosure.

FIG. 13 illustrates a structure in which a rear end of a pop-up seat is supported by a pop-up seat rear mounting part when the pop-up seat is unfolded in a walk-through pop-up seat mounting structure of a vehicle according to an embodiment of the present disclosure.

FIG. 14 illustrates a structure in which a rear end of a pop-up seat is supported by a pop-up seat rear mounting part when the pop-up seat is folded in a walk-through pop-up seat mounting structure of a vehicle according to an embodiment of the present disclosure.

### DETAILED DESCRIPTION OF ILLUSTRATIVE EMBODIMENTS

Hereinafter, some example embodiments of the present disclosure will be described in detail with reference to the accompanying drawings.

As those skilled in the art may realize, the described example embodiments may be modified in various different ways for other embodiments without departing from the spirit or scopes of the present disclosure.

In various example embodiments, components having the same configuration are representatively described using the same reference numerals.

It should be noted that the drawings are schematic and not necessarily drawn to scale.

The relative dimensions and proportions of parts in the drawings may be exaggerated or reduced in size for clarity and convenience, and any dimensions are for illustrative purposes only and are not necessarily limitative.

Where identical structures, elements, or parts appear in two or more drawings, like reference numerals may be used to indicate like features.

When it is stated that a part is “on” or “above” another part, it can be directly on the other part, or other parts may be disposed therebetween.

Some example embodiments of the present disclosure are specifically illustrated, and many variations for other embodiments of the present disclosure are possible.

Therefore, the present disclosure is not necessarily limited to a particular shape of the illustrated region of the example embodiments, and may also include modifications of the shape—for example, variations of the shape by manufacturing.

Hereinafter, with reference to drawings, a walk-through pop-up seat mounting structure of a vehicle according to some example embodiments of the present disclosure will be described.

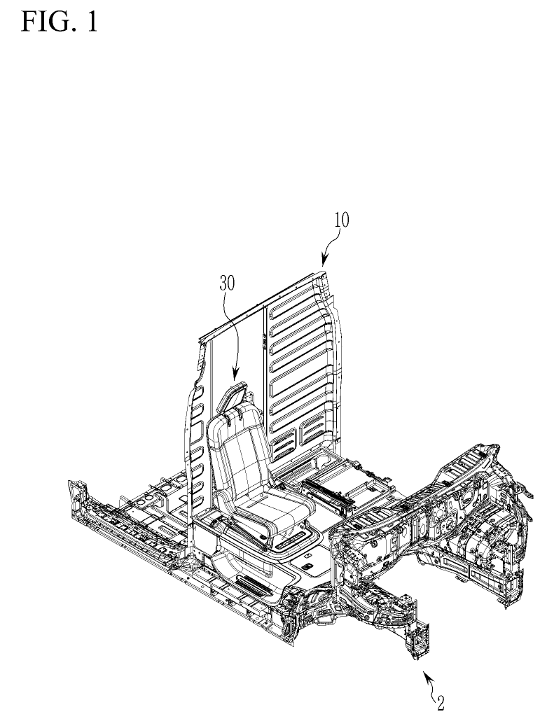

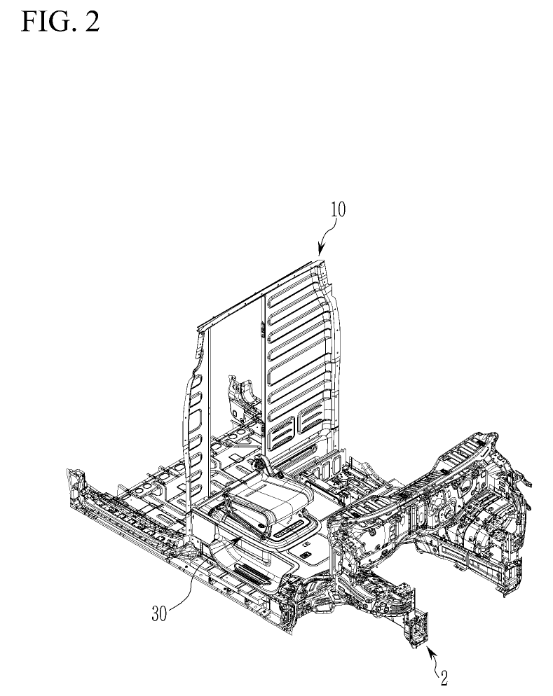

FIG. 1 illustrates an unused state of a walk-through partition wall in a walk-through pop-up seat mounting structure of a vehicle according to an embodiment of the present disclosure. FIG. 2 illustrates a state of use of a walk-through partition wall in a walk-through pop-up seat mounting structure of a vehicle according to an embodiment of the present disclosure.

As illustrated in FIGS. 1 and 2, in some embodiments, a vehicle walk-through pop-up seat mounting structure may include a walk-through partition wall 10 and a pop-up seat 30.

In some embodiments, the walk-through partition wall 10 may be provided on a front floor 2 included in the front floor surface of a vehicle body 1, and may be formed to divide a passenger compartment and a cargo room of the vehicle.

In some embodiments, the walk-through partition wall 10 may be a structure erected in the direction of the vehicle’s height, and may connect the floor and roof of the vehicle body 1 upward and downward, and may be connected to pillars on both sides.

In some embodiments, an opening may be formed in the walk-through partition wall 10 to allow the passenger compartment and cargo room to be connected.

In some embodiments, a door may be installed in the opening, and passengers may move between the passenger compartment and the cargo room by opening and closing the door.

In some embodiments, the opening may be formed on the rear side of a driver’s seat, or at the rear of a passenger seat.

In some embodiments, the pop-up seat 30 may be provided at the front of the walk-through partition wall 10 on the front floor 2 and may be provided so as to be folded or unfolded.

In some embodiments, the pop-up seat 30 may function as a passenger seat, and an opening of the walk-through partition wall 10 may be disposed at the rear of the pop-up seat 30.

As shown in FIG. 1, in some embodiments, when the pop-up seat 30 is unfolded, the walk-through partition wall 10 is in an unused state, and there is no movement of passengers between the passenger compartment and the cargo room. As shown in FIG. 2, in some embodiments, when the pop-up seat 30 is folded, passengers may move between the passenger compartment and the cargo room through the opening using the walk-through partition wall 10.

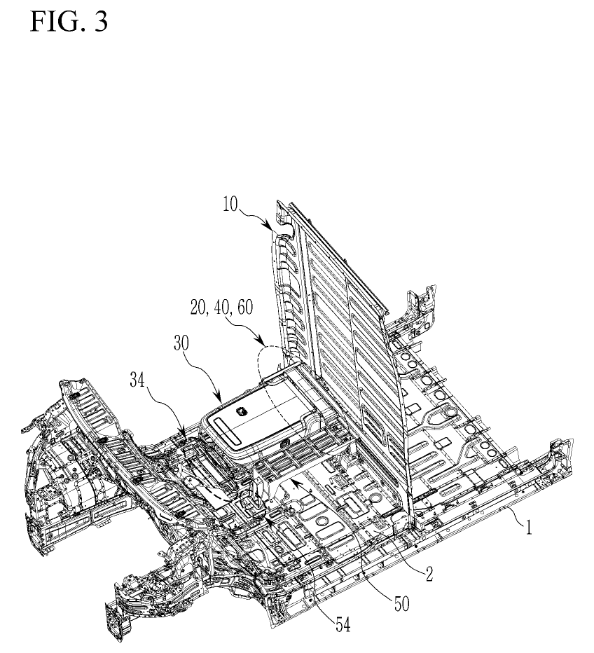

FIG. 3 illustrates a walk-through pop-up seat mounting structure of a vehicle according to an embodiment of the present disclosure.

Referring to FIG. 3, in some embodiments, the walk-through partition wall 10 and the pop-up seat 30 may be supported by a walk-through partition wall mounting part 20.

In some embodiments, the walk-through partition wall mounting part 20 may be provided between the walk-through partition wall 10 and the pop-up seat 30 on the front floor 2, and the rear of the walk-through partition wall mounting part 20 may support the walk-through partition wall 10, and the front of the walk-through partition wall mounting part 20 may support the pop-up seat 30.

In some embodiments, the walk-through partition wall mounting part 20 may be formed to extend in the horizontal direction of the vehicle body 1 and may support the bottom of the pop-up seat 30 and the bottom of the walk-through partition wall 10.

In some embodiments, a flattened footrest 50 may be further provided between the pop-up seat 30 and the driver’s seat.

In some embodiments, the flattened footrest 50 may be formed to have the same horizontal plane as the pop-up seat 30 when the pop-up seat 30 is in a folded state.

In some embodiments, when the pop-up seat 30 is folded and a passenger wants to move through the walk-through partition wall 10, the passenger may easily move to the opening of the walk-through partition wall 10 by stepping on the flattened footrest 50 and stepping on the rear surface of a backrest of the pop-up seat 30.

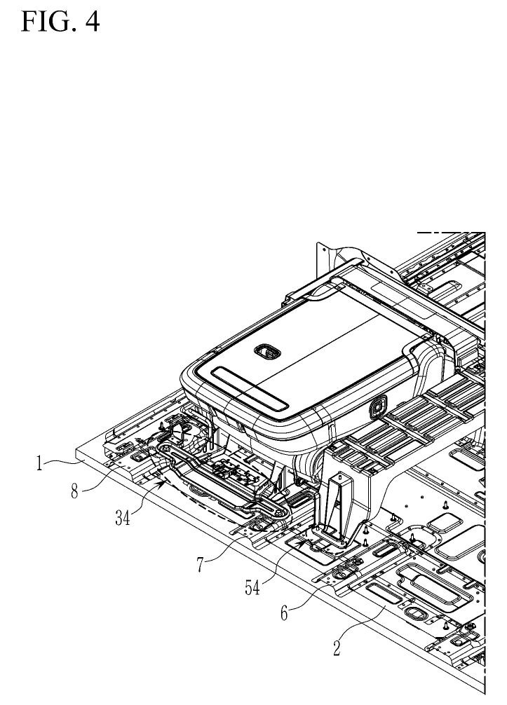

FIG. 4 illustrates a pop-up seat front mounting structure and a flattened footrest front mounting structure in a walk-through pop-up seat mounting structure of a vehicle according to an embodiment of the present disclosure.

As shown in FIG. 4, in some embodiments, the front end of the pop-up seat 30 may be mounted on a pop-up seat front mounting part 34 provided on the front floor 2.

In some embodiments, the rear end of the pop-up seat 30 may be supported by the walk-through partition wall mounting part 20, and the front end may be fixed to the pop-up seat front mounting part 34 so that the pop-up seat 30 may maintain a stable position.

In some embodiments, on both sides of the front end of the pop-up seat 30, a front inner mounting bracket 7 and a front outer mounting bracket 8 extending in the length direction of the vehicle body 1 may be further provided.

In some embodiments, the front inner mounting bracket 7 may be provided between the pop-up seat 30 and the flattened footrest 50, and the front outer mounting bracket 8 may be provided between the pop-up seat 30 and the side of the vehicle body 1.

In some embodiments, the pop-up seat front mounting part 34 may have a structure in which the front end of the pop-up seat 30 overlaps and is coupled with the upper surfaces of the front inner mounting bracket 7 and the front outer mounting bracket 8.

By this structure, in some embodiments, the front inner mounting bracket 7 and the front outer mounting bracket 8 may buffer the shock transmitted to the vehicle body 1 from being transmitted to the pop-up seat 30, thereby attenuating the vibration of the pop-up seat 30.

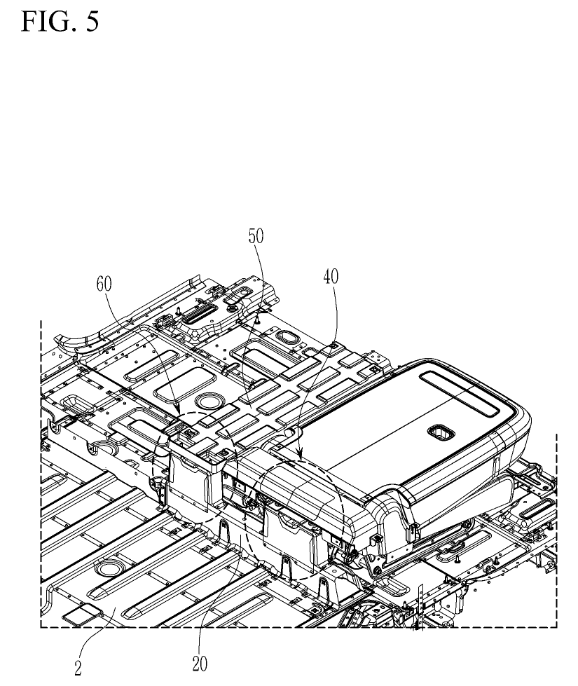

FIG. 5 illustrates a pop-up seat rear mounting structure and a flattened footrest rear mounting structure in a walk-through pop-up seat mounting structure of a vehicle according to an embodiment of the present disclosure.

As shown in FIG. 5, in some embodiments, a pop-up seat rear mounting part 40 that supports the rear end of the pop-up seat 30 may be provided at the rear of the pop-up seat 30 of the walk-through partition wall mounting part 20.

In some embodiments, at the rear of the flattened footrest 50 of the walk-through partition wall mounting part 20, a flattened footrest rear mounting part 60 that supports the rear end of the flattened footrest 50 may be provided.

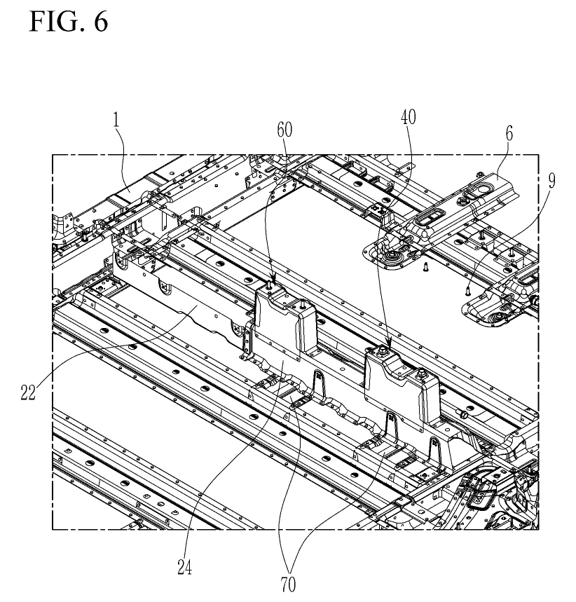

FIG. 6 illustrates a channel partition reinforcing member structure and a center floor upper member structure in a walk-through pop-up seat mounting structure of a vehicle according to an embodiment of the present disclosure.

Referring to FIG. 6, in some embodiments, the walk-through partition wall mounting part 20 may include a channel partition reinforcing member 22 that supports the walk-through partition wall 10 on the driver’s side, and a center floor upper member 24 that supports the rear end of the pop-up seat 30 on the pop-up seat 30 side.

In some embodiments, the center floor upper member 24 may be supported on the front floor 2 and may be formed in a tunnel shape including a front surface, a rear surface, and an upper surface.

In some embodiments, the center floor upper member 24 may be provided with the pop-up seat rear mounting part 40 that supports the rear end of the pop-up seat 30, and the flattened footrest rear mounting part 60 that supports the rear end of the flattened footrest 50.

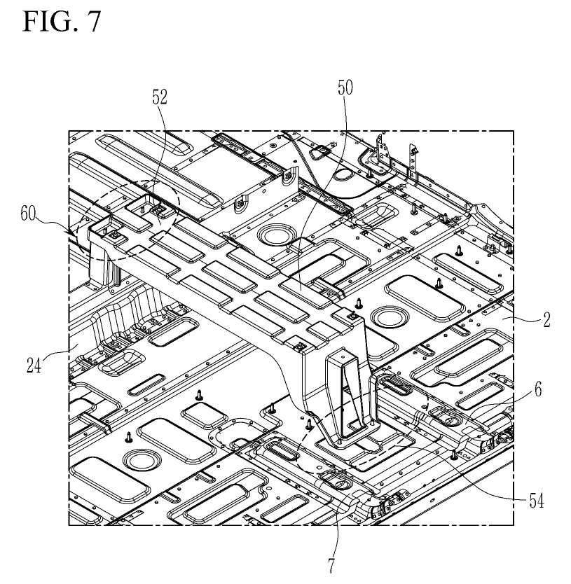

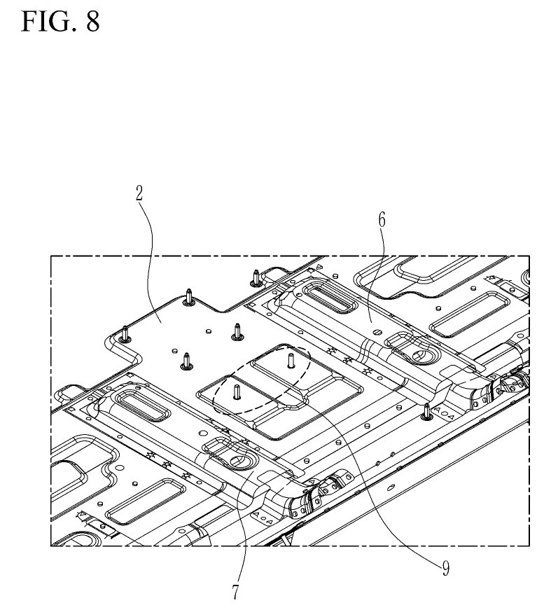

FIG. 7 illustrates a flattened footrest and a mounting structure in a walk-through pop-up seat mounting structure of a vehicle according to an embodiment of the present disclosure. FIG. 8 illustrates a mounting bracket structure provided on both sides of a flattened footrest in a walk-through pop-up seat mounting structure of a vehicle according to an embodiment of the present disclosure.

Referring to FIG. 7, in some embodiments, a flattened footrest front mounting part 54 on which the front end of the flattened footrest 50 is supported may be provided on the front floor 2.

In some embodiments, on the side of the front end of the flattened footrest 50, a front center mounting bracket 6 may be further provided such that it is spaced apart from the front inner mounting bracket 7, and the flattened footrest 50 may be disposed therebetween.

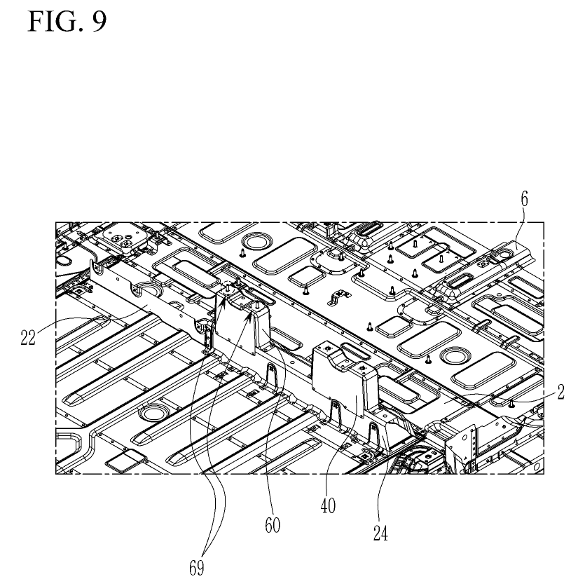

In some embodiments, the rear end of the flattened footrest 50 may be formed with a bolt coupling part 52 so as to be supported on the upper surface of the flattened footrest rear mounting part 60 and coupled by a bolt 69 (see, e.g., FIG. 9).

In some embodiments, as shown in FIG. 8, the front end of the flattened footrest 50 may be fixed by a bolt 9 provided on the front floor 2.

FIG. 9 illustrates a pop-up seat rear mounting part and a flattened footrest rear mounting part in a walk-through pop-up seat mounting structure of a vehicle according to an embodiment of the present disclosure.

As shown in FIG. 9, in some embodiments, the flattened footrest rear mounting part 60 may be provided on the upper surface of the center floor upper member 24, and the bolt 69 may be provided protrudingly on the flattened footrest rear mounting part 60.

In some embodiments, the bolt coupling part 52 formed at the rear end of the flattened footrest 50 may be connected to the bolt 69 so that the flattened footrest 50 may be supported and coupled.

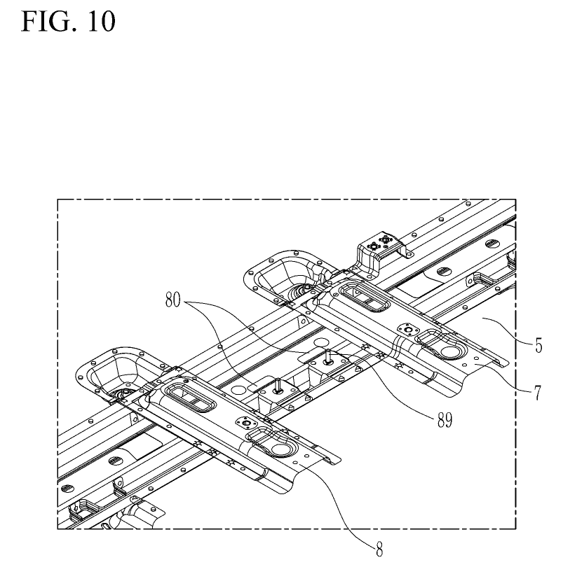

FIG. 10 illustrates a structure of mounting brackets provided on both sides of a pop-up seat and a stay mounting bracket disposed therebetween in a walk-through pop-up seat mounting structure of a vehicle according to an embodiment of the present disclosure.

Referring to FIG. 10 together with FIG. 6, in some embodiments, at the bottom of the front floor 2, a battery crossmember 5 extending in a horizontal direction of the vehicle body 1, and a lower support structure bracket 70 connected to the battery crossmember 5 and extending in the length direction of the vehicle body 1 may be provided.

In some embodiments, a stay mounting bracket 80 may be inserted and connected to the battery crossmember 5, and the stay mounting bracket 80 may be connected to the bottom of the pop-up seat 30 on the lower surface of the front floor 2.

In some embodiments, the bottom of the pop-up seat 30 may be coupled by a bolt 89 protruding from the stay mounting bracket 80.

In some embodiments, on both sides of the pop-up seat 30 (coupled to the stay mounting bracket 80), the front inner mounting bracket 7 and the front outer mounting bracket 8 (coupled to the battery crossmember 5) may be disposed.

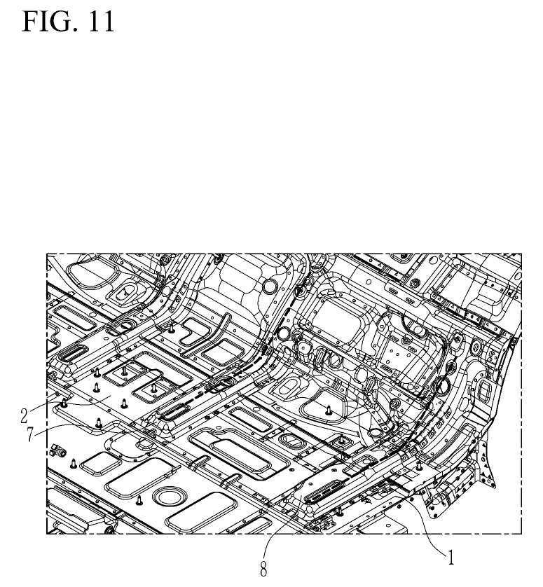

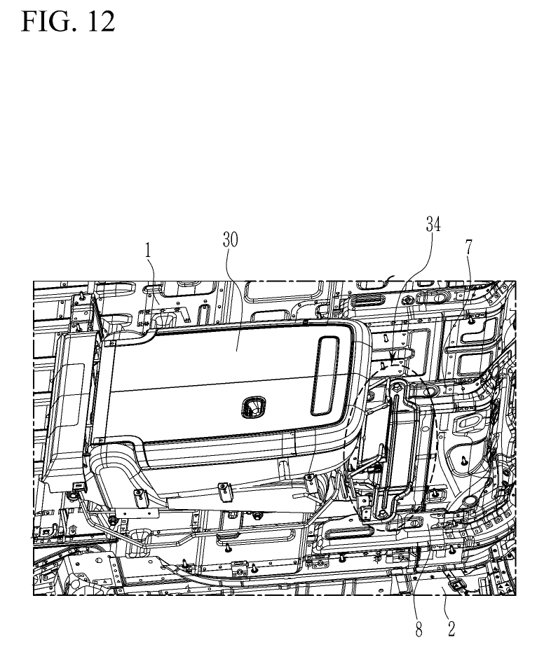

FIG. 11 illustrates a vehicle body connection structure of mounting brackets provided on both sides of a pop-up seat in a walk-through pop-up seat mounting structure of a vehicle according to an embodiment of the present disclosure. FIG. 12 illustrates a pop-up seat front mounting part in a walk-through pop-up seat mounting structure of a vehicle according to an embodiment of the present disclosure.

Referring to FIGS. 11 and 12, in some embodiments, the front inner mounting bracket 7 and the front outer mounting bracket 8 provided on both sides of the front end of the pop-up seat 30 may be connected to the front side of the vehicle body 1, and the front end of the pop-up seat 30 may be overlapped and coupled to the upper surfaces of the front inner mounting bracket 7 and the front outer mounting bracket 8.

By this structure in some embodiments, the impact transmitted to the vehicle body is transmitted to other parts of the vehicle body 1 through the front inner mounting bracket 7 and the front outer mounting bracket 8 so that the impact may be prevented from being concentrated on the pop-up seat 30, and the vibration of the pop-up seat 30 may be attenuated.

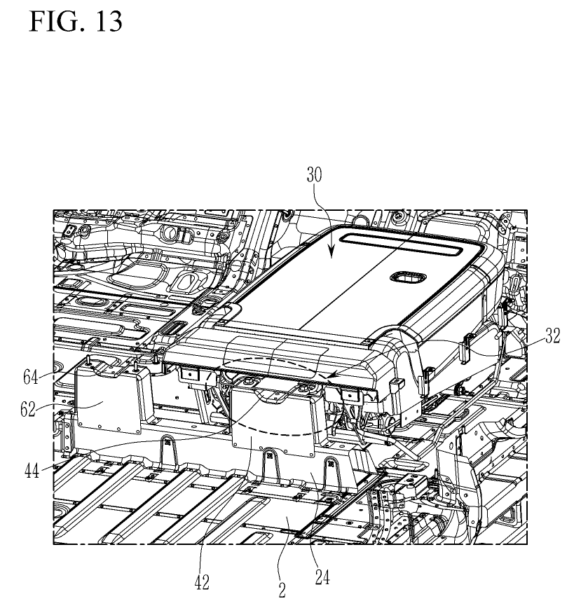

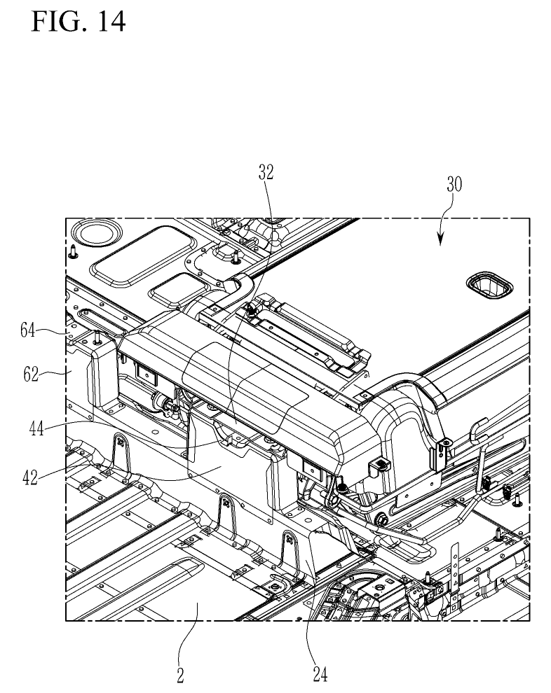

FIG. 13 illustrates a structure in which the rear end of a pop-up seat is supported by a pop-up seat rear mounting part when the pop-up seat is unfolded in a walk-through pop-up seat mounting structure of a vehicle according to an embodiment of the present disclosure. FIG. 14 illustrates a structure in which the rear end of a pop-up seat is supported by a pop-up seat rear mounting part when the pop-up seat is folded in a walk-through pop-up seat mounting structure of a vehicle according to an embodiment of the present disclosure.

As shown in FIGS. 13 and 14, in some embodiments, the pop-up seat rear mounting part 40 may include a center floor reinforcing member 44 coupled in a protruding form to the upper surface of the center floor upper member 24, and a center floor rear tunnel stay 42 covering the center floor reinforcing member 44 and having a lower portion that is coupled to the front and rear surfaces of the center floor upper member 24.

In some embodiments, at the rear end of the pop-up seat 30, a pop-up seat rear support 32 may be formed to be supportively coupled to the upper surface of the pop-up seat rear mounting part 40—i.e., the upper surface of the center floor reinforcing member 44.

On the other hand, in some embodiments, the flattened footrest rear mounting part 60 may include a center support mounting bracket 64 coupled in a protruding form to the upper surface of the center floor upper member 24, and a center support mounting bracket cover member 62 covering the center support mounting bracket 64 and having a lower portion that is coupled to the front and rear surfaces of the center floor upper member 24.

In some embodiments, the center floor rear tunnel stay 42 and the center support mounting bracket cover member 62 may be coupled to the front and rear surfaces of the center floor upper member 24 by a plurality of bolts.

In some embodiments, when the pop-up seat 30 is folded, the rear surface of the backrest of the pop-up seat 30 may form a horizontal plane at the same height as the upper surface of the flattened footrest 50, and may function as a footrest for passengers to move within the passenger compartment.

In this way, according to some embodiments of the present disclosure, a foldable pop-up seat that functions as a passenger seat may be disposed in the passenger compartment of a vehicle, and it may be possible to freely move between the passenger compartment and the cargo room through the walk-through partition wall without getting out of the vehicle, thereby improving space utilization and convenience of movement.

In some embodiments, by adding a reinforcing member that supports the walk-through partition wall and a rigid member that supports the pop-up seat, the supporting rigidity may be secured.

In some embodiments, by adding a flattened footrest to the side of the pop-up seat, the flattened footrest may serve as a footrest when moving to the cargo room and support the load, thereby improving the convenience of movement and securing rigidity.

In some embodiments, by sharing various design elements of current vehicle models and adding walk-through partition walls, pop-up seats, and flattened support structures, there may be a cost-saving effect through shared use of the basic vehicle.

While the example embodiments of the present disclosure have been described in detail, it may be understood that the present disclosure is not necessarily limited to the disclosed example embodiments, but on the contrary, the present disclosure is intended to cover various modifications and equivalent arrangements for other embodiments included within the spirit and scopes of the appended claims and equivalents thereof.

What is claimed is:

1. A walk-through pop-up seat mounting structure of a vehicle, comprising:
a walk-through partition wall disposed on a front floor that provides a front bottom surface of a vehicle body, wherein the walk-through partition wall divides a passenger compartment and a cargo room of the vehicle;
a pop-up seat mounted in front of the walk-through partition wall on the front floor, wherein the pop-up seat is configured to be folded or unfolded; and
a walk-through partition wall mounting part mounted between the walk-through partition wall and the pop-up seat on the front floor, wherein the pop-up seat is supported by the walk-through partition wall mounting part.

2. The walk-through pop-up seat mounting structure of the vehicle of claim 1, wherein the walk-through partition wall mounting part comprises:
a channel partition reinforcing member supporting the walk-through partition wall; and
a center floor upper member supporting a rear end of the pop-up seat.

3. The walk-through pop-up seat mounting structure of the vehicle of claim 2, wherein the center floor upper member includes a pop-up seat rear mounting part supporting the rear end of the pop-up seat.

4. The walk-through pop-up seat mounting structure of the vehicle of claim 3, wherein at the rear end of the pop-up seat, the pop-up seat comprises a pop-up seat rear support supportively coupled to an upper surface of the pop-up seat rear mounting part.

5. The walk-through pop-up seat mounting structure of the vehicle of claim 2, further comprising a flattened footrest disposed at a side of the pop-up seat on the front floor,
wherein a top surface of the flattened footrest is at a same horizontal plane as a back surface of the pop-up seat based on the pop-up seat being in a folded state.

6. The walk-through pop-up seat mounting structure of the vehicle of claim 5, further comprising a flattened footrest rear mounting part connected on the center floor upper member,
wherein the flattened footrest rear mounting part supports a rear end of the flattened footrest.

7. The walk-through pop-up seat mounting structure of the vehicle of claim 6, wherein the flattened footrest rear mounting part comprises:
a center support mounting bracket coupled to and protruding from an upper surface of the center floor upper member; and
a center support mounting bracket cover member covering the center support mounting bracket and having a lower portion that is coupled to front and rear surfaces of the center floor upper member.

8. The walk-through pop-up seat mounting structure of the vehicle of claim 4, wherein the pop-up seat rear mounting part comprises:
a center floor reinforcing member coupled to and protruding from an upper surface of the center floor upper member; and
a center floor rear tunnel stay covering the center floor reinforcing member and having a lower portion that is coupled to front and rear surfaces of the center floor upper member.

9. The walk-through pop-up seat mounting structure of the vehicle of claim 8, further comprising a pop-up seat front mounting part disposed on the front floor,
wherein a front end of the pop-up seat is mounted on the pop-up seat front mounting part.

10. The walk-through pop-up seat mounting structure of the vehicle of claim 9, further comprising a front inner mounting bracket and a front outer mounting bracket extending in a length direction of the vehicle body on both sides of the front end of the pop-up seat.

11. The walk-through pop-up seat mounting structure of the vehicle of claim 7, further comprising a flattened footrest front mounting part disposed on the front floor,
wherein the flattened footrest front mounting part supports a front end of the flattened footrest.

12. The walk-through pop-up seat mounting structure of the vehicle of claim 11, further comprising:
a battery crossmember extending in a horizontal direction of the vehicle body at a bottom of the front floor; and
a lower support structure bracket connected to the battery crossmember and extending in a length direction of the vehicle body at the bottom of the front floor .

13. The walk-through pop-up seat mounting structure of the vehicle of claim 12, further comprising a stay mounting bracket inserted in and connected to the battery crossmember, wherein the stay mounting bracket is connected to a bottom of the pop-up seat on a lower surface of the front floor.

14. The walk-through pop-up seat mounting structure of the vehicle of claim 10, further comprising:
a flattened footrest disposed at a side of the pop-up seat on the front floor; and
a front center mounting bracket disposed on a side of a front end of the flattened footrest, wherein the front center mounting bracket is spaced apart from the front inner mounting bracket such that the flattened footrest is disposed between the front center mounting bracket and the front inner mounting bracket.

15. A vehicle comprising:
a front floor;
a passenger compartment;
a cargo room;
a walk-through partition wall disposed on the front floor between the passenger compartment and the cargo room, wherein the walk-through partition wall includes a passage opening;
a foldable seat mounted in front of the walk-through partition wall on the front floor at the passage opening, wherein the foldable seat is configured to be folded or unfolded; and
a walk-through partition wall mounting part mounted between the walk-through partition wall and the foldable seat on the front floor, wherein the foldable seat is supported by the walk-through partition wall mounting part.

16. The vehicle of claim 15, further comprising a flattened footrest disposed adjacent the foldable seat on the front floor,
wherein a top surface of the flattened footrest is at a same horizontal plane as a back surface of the foldable seat based on the foldable seat being in a folded state.

17. The vehicle of claim 16, further comprising a driver seat, wherein the flattened footrest is disposed between the driver seat and the foldable seat.

18. The vehicle of claim 15, wherein a back surface of the foldable seat is configured to be horizontal and configured to be stepped on based on the foldable seat being in a folded state.

19. A vehicle comprising:
a front floor;
a passenger compartment;
a cargo room;
a walk-through partition wall disposed on the front floor between the passenger compartment and the cargo room, wherein the walk-through partition wall includes a passage opening;
a foldable seat mounted in front of the walk-through partition wall on the front floor at the passage opening, wherein the foldable seat is configured to be folded or unfolded, wherein a back surface of the foldable seat is configured to be horizontal and configured to be stepped on based on the foldable seat being in a folded state; and
a walk-through partition wall mounting part mounted between the walk-through partition wall and the foldable seat on the front floor, wherein the foldable seat is supported by the walk-through partition wall mounting part.

20. The vehicle of claim 19, further comprising a flattened footrest disposed adjacent the foldable seat on the front floor,
wherein a top surface of the flattened footrest is at a same horizontal plane as the back surface of the foldable seat based on the foldable seat being in a folded state.
